(19) United States
(12) Patent Application Publication
(10) Pub. No.: US 2009/0089464 A1
(43) Pub. Date: Apr. 2, 2009

(54) MODULAR I/O VIRTUALIZATION FOR BLADE SERVERS

(75) Inventors: Jorge E. Lach, Lexington, MA (US); Paul G. Phillips, Westborough, MA (US)

Correspondence Address: OSHA LIANG L.L.P./SUN, TWO HOUSTON CENTER, 909 FANNIN, SUITE 3500, HOUSTON, TX, 77010, US

(73) Assignee: Sun Microsystems, Inc., Santa Clara, CA (US)

(21) Appl. No.: 11/862,973

(22) Filed: Sep. 27, 2007

(51) Int. Cl. G06F 13/14

(52) U.S. Cl. 710/62

(57) ABSTRACT

An apparatus includes a server comprising n operating system images and an IOV aware root complex; a plurality of physical I/O devices comprising n virtual I/O functions; and a PCI Express bus operatively connected to the server and the plurality physical I/O devices via the root complex, wherein the root complex is operable to provide communication between the n operating system images and the n virtual I/O function, and wherein the server and the plurality of physical I/O devices are modules in a chassis.

### BACKGROUND OF INVENTION

Traditional server systems were designed so that each server had dedicated input/output (I/O) devices. The I/O devices were either integrated onto the server motherboard or added by the vendor or customer in form of an add-in card, such as PCI (Peripheral Component Interconnect) or PCI-Express adapter cards. All resources of the I/O device were utilized only by the associated server. When multiple servers are deployed together, say in a network, each server has a dedicated network adapter that performs the required I/O functions. These servers are usually connected to a network switch, which has a port reserved for each server.

FIG. 1 shows a set of servers, Server-1 101 to Server-n 105, each having dedicated I/O devices I/O-1 107 to I/O-n 111, respectively. The I/O devices I/O-1 107 to I/O-n 111 may be 10 gigabit network connections dedicated to the servers Server-I 101 to Server-n 105, respectively. Depending upon the load on the servers, this configuration may result in the underutilization of each of the 10 gigabit switch connections. Because 10 gigabit ports are expensive, the underutilization may have a large impact on the economics associated with the operation of the servers.

Each server is usually limited to hosting a single application to avoid operating system (OS) conflicts. When an application is deployed onto a server, I/O devices are allocated and the system is configured in order to host that particular application. For example, in certain networking applications, dedicated I/O devices—a network adapter and a storage adapter—are allocated to the server. The system configuration involves installing an OS and application software on the server, configuring the local adapters, connecting the server to switches, configuring the network and storage fabric to associate those connections to the required network and storage devices, etc. In scenarios where an application needs to be moved due to server failure or other reasons, the server to which the application is moved needs to be reconfigured again. The resources involved in such reconfigurations may also negatively impact the cost of operation of the server due to long server downtime.

### SUMMARY OF INVENTION

One or more embodiments of the present invention relate to an apparatus comprising: a server comprising n operating system images and an IOV aware root complex; a plurality of physical I/O devices comprising n virtual I/O functions; and a PCI Express bus operatively connected to the server and the plurality physical I/O devices via the root complex, wherein the root complex is operable to provide communication between the n operating system images and the n virtual I/O functions, and wherein the server and the plurality of physical I/O devices are modules in a chassis.

One or more embodiments of the present invention relate to an apparatus comprising: a plurality of servers, each server comprising n operating system images and an IOV aware root complex; a plurality of physical I/O devices, each physical I/O device comprising n virtual I/O functions; a PCI Express switch fabric comprising a plurality of upstream ports respectively connected to the plurality of servers and a plurality of downstream ports connected to the plurality of physical I/O devices; an IOV management entity operable to provide communication between any one of the n operating system images and at least one I/O virtual function, wherein the plurality of servers and the plurality of devices are modules in a chassis.

One or more embodiments of the present invention relate to an interconnect fabric comprising: a plurality of ports configured as upstream ports, each upstream port operatively connected to a server; a plurality of ports configured as downstream ports, each downstream port operatively connected to a physical I/O device; and an I/O virtualization management entity operable to provide communication between at least one of the upstream ports and at least one of the downstream ports, wherein the interconnect fabric supports I/O virtualization of the I/O devices connected to the downstream ports.

Other aspects and advantages of the invention will be apparent from the following description and the appended claims.

### BRIEF DESCRIPTION OF DRAWINGS

FIG. 1 shows dedicated I/O devices connected to servers.

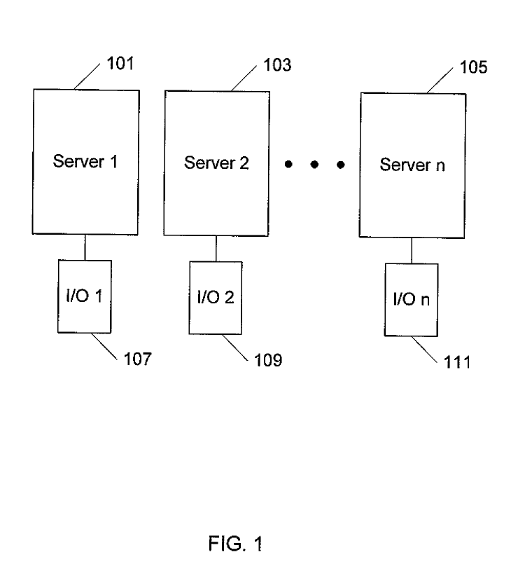

FIG. 2 shows a single server sharing a single physical I/O device in accordance with an embodiment of the present invention.

FIG. 3 shows multiple servers sharing multiple physical I/O devices in accordance with an embodiment of the present invention.

FIG. 4 shows ten blade servers sharing three physical I/O devices in accordance with an embodiment of the present invention.

FIG. 5 shows a network express module in accordance with an embodiment of the present invention.

FIG. 6 shows blade servers connected to several I/O devices in accordance with an embodiment of the present invention.

FIG. 7 shows blade servers connected to several I/O devices in accordance with an embodiment of the present invention.

### DETAILED DESCRIPTION

In one aspect, some embodiments enclosed herein relate to systems for sharing I/O devices among multiple servers, hosts, and applications. In particular, embodiments of the present invention relate to virtualization of I/O devices based on the PCI-Express I/O virtualization.

Embodiments of the present invention are described in detail below with respect to the drawings. Like reference numbers are used to denote like parts throughout the figures.

Virtualization is a set of technologies that allow multiple applications to securely share the server hardware, allow applications to be moved easily and efficiently from one server to another, and allow network and storage connections to track changes in the allocations of applications to hardware without requiring administrative action on the network or storage fabrics.

With I/O virtualization, the I/O devices themselves have logic that allows them to serve multiple entities. The servers may run multiple OS images, where each OS image may run a particular application. I/O virtualization allows multiple OSs to share a single I/O device.

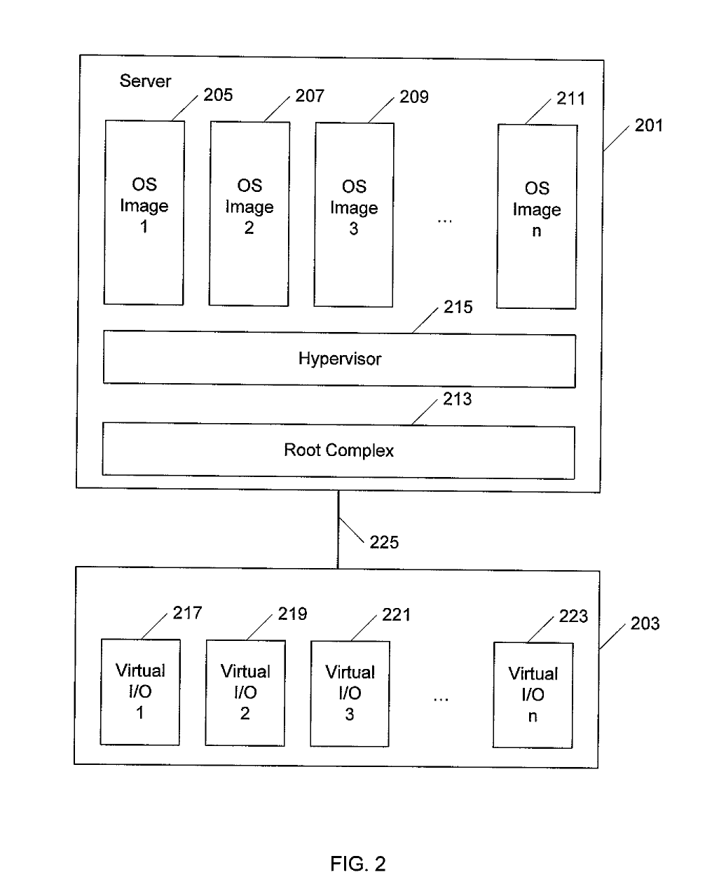

FIG. 2 shows a single physical server 201 sharing an I/O device 203 in accordance with an illustrative embodiment of the present invention. The server 201 has multiple operating system images, OS Image-1 205 to OS Image-n 211, an I/O virtualization (IOV) root complex 213 and a hypervisor 215. The I/O device 203 has multiple virtual I/O functions, Virtual I/O-1 217 to Virtual I/O-n 223, where each virtual I/O function is assigned to one OS image of the server 201. The I/O device 203 is connected to the server 201 via a PCI-Express bus 225. The OS images, OS Image-1 205 to OS Image-n 211, access the PCI-Express bus 225 through the IOV aware root complex 213. The IOV aware root complex 213 allows transactions from each OS image to be correctly routed to the virtual I/O function assigned to it.

The root complex 213 connects the processor and memory subsystem (not shown) of the server 201 to the PCI-Express bus 225 through a PCI-Express port (not shown). Its function is similar to a host bridge in a PCI system. The root complex 213 generates transaction requests on behalf of the processor, which is interconnected through a local bus (not shown). The root complex 213 may be implemented as a discrete device (e.g., a custom design CMOS chip, an FPGA chip) or may be integrated with the processor. The root complex 213 may have more than one PCI-Express port, which may, in turn, be connected to multiple PCI-Express buses or PCI-Express switches.

Each of the virtual I/O functions, Virtual I/O-1 217 to Virtual I/O-n 223, may direct memory access (DMA) engine. The DMA engine moves data back and forth between the memory associated with the associated OS image in the server 201 and the virtual I/O function in the I/O device 203. The root complex 213 is used to directly map each OS image to a virtual I/O function within the I/O device 203.

The hypervisor 215 allows multiple OS images, OS Image-1 205 to OS Image-n 211, to simultaneously run on a single server. The hypervisor 215 may be considered as a operating system onto itself, on which multiple guest OSs are installed. Each guest OS operates as if it owned all of the server hardware. The guest OSs may also run simultaneously. For example, in FIG. 2, the OS image-1 205 may be a Windows® operating system while the OS image-2 207 may be a Solaris® operating system.

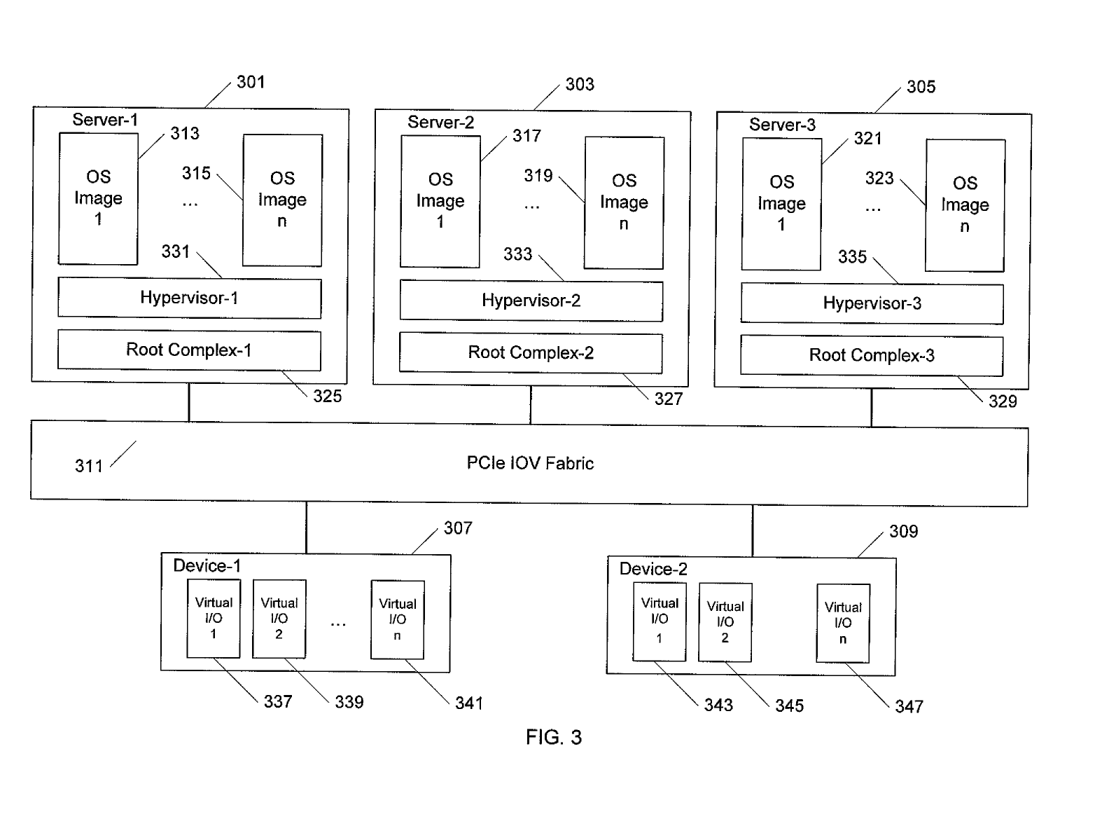

FIG. 3 shows a system where multiple servers share one or more physical I/O devices in accordance with an illustrative embodiment of the present invention. Those skilled in the art will appreciate that the system may be a blade server, i.e., a system comprising modularized servers sharing a chassis interconnect. The common chassis provides services such as power, cooling, management services, and various interconnect functions. Because these services are all centralized in the chassis and shared between the blades, the overall efficiency of the system is improved. Additionally, advantages such as modularity, ease-of-service, density, power, and reliability and serviceability (RAS) are achieved by blade servers. Different embodiments of blade servers vary in chassis size and number of blades.

As can be seen in FIG. 3, servers server-1 301, server-2 303, and server-3 305 are connected to physical I/O devices 307 and 309 through a PCI-Express IOV fabric 311. Each server comprises of multiple OS images, OS Image-1 to OS Image-n. The OS images in server-1 301 are labeled 313 to 315. The OS images hosted on server-2 303 are labeled 317 to 319. And the OS images hosted on server-3 305 are labeled 321 to 323. Each server also includes a root complex. The root complexes for server-1 301, server-2 303, and server-3 305 are labeled root complex-1 325, root complex-2 327, and root complex-3 329, respectively. The hypervisors associated with server-1 301, server-2 303, and server-3 305 are labeled hypervisor-1 331, hypervisor-2 333, and hypervisor-3 335, respectively.

Two physical I/O devices device-1 307 and device-2 309 are connected to the downstream ports of the PCIe IOV Fabric 311. Each I/O device includes virtual I/O functions. The n virtual I/O functions included in device-1 307 are labeled 337 to 341. The virtual I/O devices included in device-2 309 are labeled 343 to 347.

The upstream ports of the shared PCIe IOV Fabric 311 are connected to the servers, while the downstream ports are connected to the physical I/O devices. The PCIe IOV Fabric 311 may be composed of a single switch or multiple switches and a IO management unit (not shown). The IO management unit maintains port mappings that allows each server to build its own I/O device tree and assign device addresses independently of other systems. The mappings are dependent on the system design, which determines the server and I/O device connectivity architecture. When address mappings are established prior to a system being booted, the BIOS in the system determines the available I/O devices behind the PCIe IOV Fabric 311 and proceeds to configure them in a manner similar to when it configures dedicated I/O devices. When mappings are torn down while the server is running, changes in the I/O configurations is conveyed as PCI-Express “hot-plug events,” which will result in the operating system adding or removing the particular devices from its device tree. The hot plug capability allows insertion and removal of I/O devices while the main power is maintained to the system. Therefore, powering down the entire platform in order to plug and unplug devices is not necessary.

The PCIe IOV fabric 311 establishes a hierarchy associated with each root complex 325, 327, and 329. A hierarchy includes all the devices and links associated with a root complex that are either directly connected to the root complex via its ports, or indirectly connected via switches and bridges.

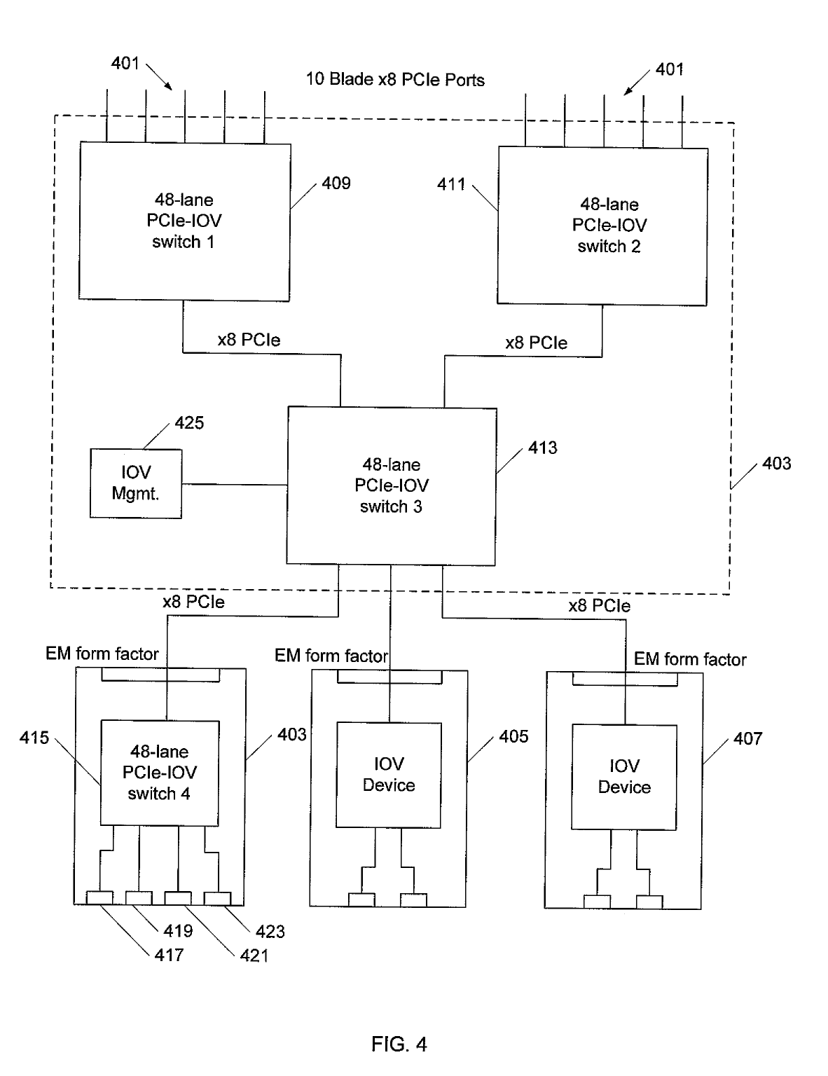

FIG. 4 shows 10 blade servers sharing three physical I/O devices through a PCIe IOV fabric in accordance with an illustrative embodiment of the present invention. Each blade server (not sown) has a x8 PCI Express connection 401 to the shared PCIe IOV fabric 311. The fabric is built using three 48-lane PCIe IOV switches 409-413. This results in a 5:1 blocking factor. The physical I/O devices 403, 405, and 407 connect to the downstream ports of the PCIe IOV Fabric 311 via x8 PCI Express connection. The two physical I/O devices 405 and 407 are generic IOV devices, e.g., Ethernet, Fibre Channel adapter, SAS adapter, etc. The leftmost physical I/O device 403 is an expansion express module that includes a PCI Express switch PCI Express Switch-4 415. The expansion express module 403 allows expansion of the root complex hierarchy. The output of the PCI Express switch-4 415 is connected to four x8 PCI Express connectors 417-423. Multiple systems with expansion express modules may be connected via x8 PCI Express cables to configure desired topologies. The IOV Management unit 425 maintains the port mappings that allows each server to build its own I/O device tree and assign device addresses independently of other systems.

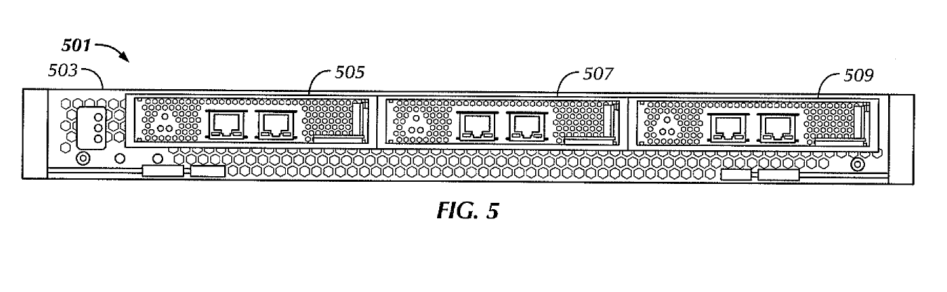

The physical I/O devices described above are designed in an industry standard form factor—the PCI Express Express Module (EM). The form factor of the Express modules is specified by the PCI Express special interest group (PCISIG). The physical I/O devices 403-407 may be separate modules within a chassis supporting the system. Alternatively, they may be grouped into one single module called the Network Express Module (NEM). An NEM provides aggregation of I/O resources to within a single module. FIG. 5 shows an NEM 501 in accordance with an illustrative embodiment of the present invention. The external module 503 encloses three Express Modules 505-509. Each of the EMs may be a network I/O device such as an adapter for Ethernet, Fibre Channel, SAS, etc. The NEM comes in a form factor that allows it to be inserted as an module in a blade server chassis. The dimensions for the NEM 501 are not limited to the ones shown in FIG. 5.

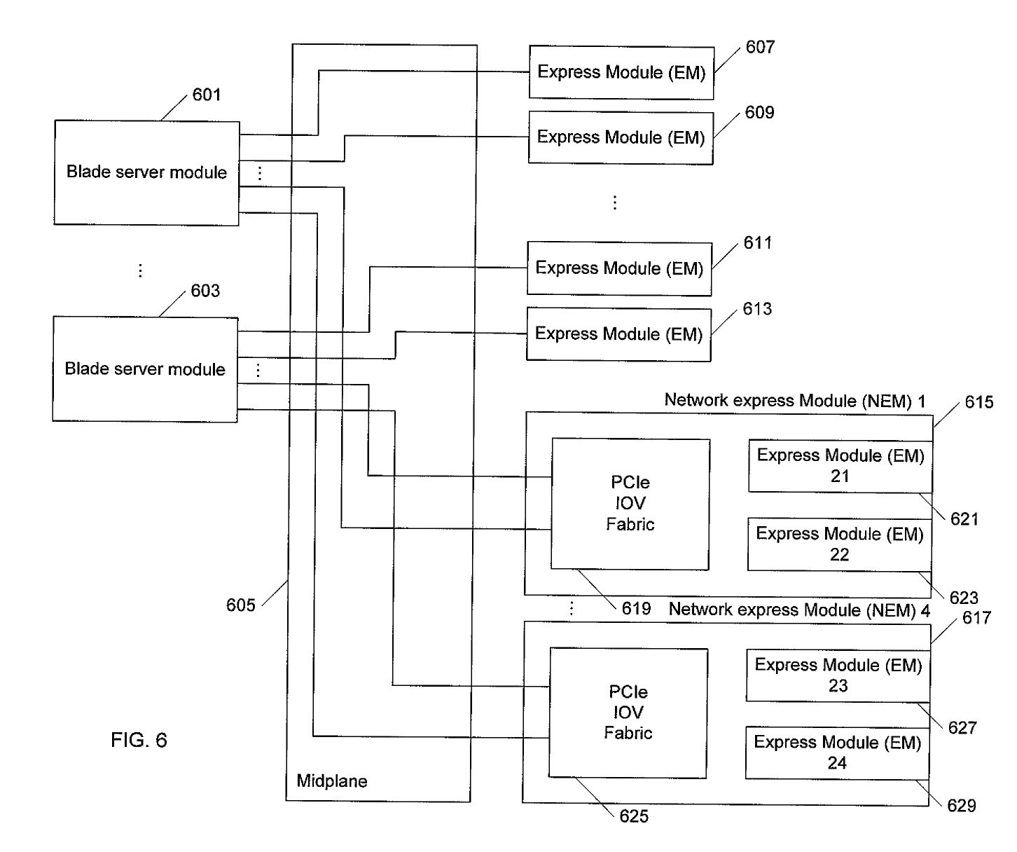

FIG. 6 shows a schematic of blade servers connected to a number of I/O devices in accordance with an illustrative embodiment of the present invention. Ten blade server modules, Blade server module-1 601 to Blade server module-10 603 are modules in a computer system chassis. The Blade server modules 601-603 may host single or multiple operating systems, each operating system, in turn, running single or multiple applications. Each Blade server module is connected to a midplane 605 via PCI Express links. The bandwidth of these links may vary according to the design specification. The midplane 605 provides physical connectivity between the Blade server modules and physical I/O devices. The midplane 605 provides power to each module on the computer system chassis (not shown). The midplane also provies PCI Express interconnect between the PCI Express root complexs on each of the Blade server modules 601-603 to the EMs and NEMs installed in the chassis.

Two EMs are dedicated to each Blade server module. Express module-1 607 and Express module-2 609 are directly connected to Blade server module-1 601. Similarly, Express module-19 611 and Express module-20 613 are directly connected to Blade server module-10 603. The dedicated EMs are not sharable by multiple servers. However, each dedicated EM may be shared by multiple operating systems installed on the associated blade server module.

Four Network Express modules NEMs are also connected to the blade servers through the midplane 605. NEM-1 615 is connected to each Blade server module 601-603. Similarly, NEM-4 617 is connected to each Blade server module 601-603. The configuration shown allows each NEM to be shared by all the blade server modules on the computer system chassis. The NEM-1 615 includes a PCI Express IOV fabric 619 and two Express modules 621 and 622. The root complexes of the Blade servers 601-603 access the virtual I/O functions of Express modules 621 and 622 of the NEM-1 via the PCI Express IOV fabric 619. Similarly, NEM-4 617 also includes a PCI Express IOV fabric 625 and two Express modules 627 and 629.

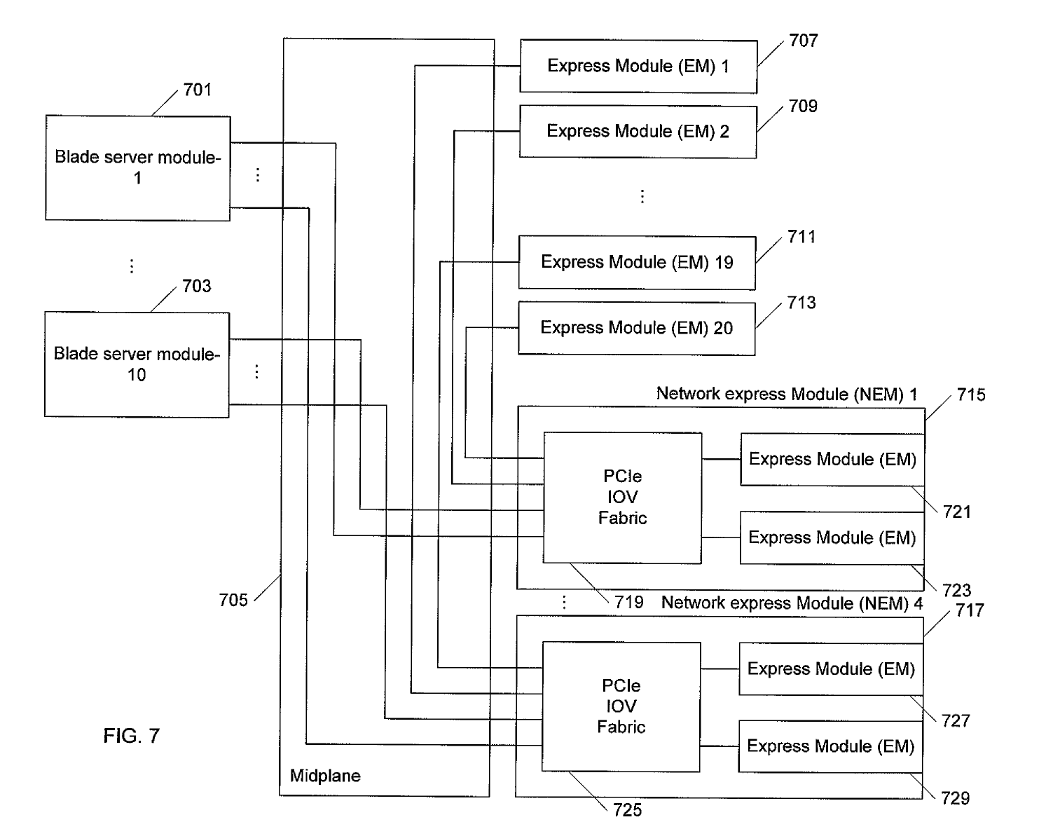

FIG. 7 shows a schematic of blade servers connected to a number of I/O devices in accordance with an illustrative embodiment of the present invention. In the shown embodiment, the Express modules EM-1 707 to EM-20 713, are not dedicated to any particular blade server module. EM-1 707 is connected to a downstream port of the PCI Express IOV fabric 719 of the NEM-1 715. Similarly, all the other EMs, EM-2 709 to EM-20 713 are connected to PCI Express IOV fabrics of various NEMs on the computer system chassis. The configuration shown allows the EMs to be shared by all the blade server modules 701-703 adding more flexibility.

Advantages of the present invention may include one or more of the following. In one or more embodiments of the present invention, resources of a physical I/O device are shared by multiple servers using I/O virtualization. Each of the servers may have multiple operating systems running different applications. This configuration allows full utilization of the resources of the physical I/O device-reducing operating costs and increasing efficiency.

In one or more embodiments of the present invention, blade server modules share physical I/O devices in industry standard form factors using I/O virtualization. The modular design allows for higher computing density by providing more processing power per rack unit than that with conventional rack-mount systems; allows increased serviceability and availability by featuring shared common system components such as power, cooling, and I/O interconnects; allows reduced complexity through fewer required components, cable and component aggregation, and consolidated management; allows lower costs by providing ease of serviceability and low acquisition costs.

The industry standard form factor eliminates the disadvantages associated with being locked on to a single vendor. The user is no longer limited by a single vendor's innovation. The ability to use I/O devices from several vendors drives costs lower and at the same time increases availability. The industry standard form factor, along with modular design, provides greater efficiency and lower operation costs to the end user.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus comprising:
a server comprising n operating system images and an IOV aware root complex;
a plurality of physical I/O devices comprising n virtual I/O functions; and
a PCI Express bus operatively connected to the server and the plurality physical I/O devices via the root complex,
wherein the root complex is operable to provide communication between the n operating system images and the n virtual I/O function, and
wherein the server and the plurality of physical I/O devices are modules in a chassis.

2. The apparatus of claim 1, wherein at least one of the plurality of physical I/O device modules is in industry standard form factor.

3. The apparatus of claim 1, wherein the server is a blade server.

4. The apparatus of claim 1, wherein the OS image is connected to the virtual I/O function of at least one the plurality of physical I/O devices.

5. An apparatus comprising:
a plurality of servers, each server comprising n operating system images and an IOV aware root complex;
a plurality of physical I/O devices, each physical I/O device comprising n virtual I/O functions;
a PCI Express switch fabric comprising a plurality of upstream ports respectively connected to the plurality of servers and a plurality of downstream ports connected to the plurality of physical I/O devices;
an IOV management entity operable to provide communication between any one of the n operating system images and at least one I/O virtual function,
wherein the plurality of servers and the plurality of devices are modules in a chassis.

6. The apparatus of claim 5, wherein at least one of the plurality of physical I/O device modules is in industry standard form factor.

7. The apparatus of claim 5, wherein at least one of the plurality of physical I/O devices are in a Network Express Module form factor.

8. The apparatus of claim 5, wherein at least one of the n virtual I/O functions of the physical I/O device is connected to an I/O port of the physical I/O device.

9. An interconnect fabric comprising:
a plurality of ports configured as upstream ports, each upstream port operatively connected to a server;
a plurality of ports configured as downstream ports, each downstream port operatively connected to a physical I/O device; and
wherein communication is provided between at least one of the upstream ports and at least one of the downstream ports,
wherein the interconnect fabric supports I/O virtualization of the I/O devices connected to the downstream ports.

10. The interconnect fabric of claim 9, wherein the servers are modular.

11. The interconnect fabric of claim 10, wherein the server hosts a plurality of operating system images.

12. The interconnect fabric of claim 10, wherein the plurality of servers are blade servers.

13. The interconnect fabric of claim 9, wherein the physical I/O devices are modular.

14. The interconnect fabric of claim 13, wherein at least one of the physical I/O devices are in industry standard form factor.

15. The interconnect fabric of claim 13, wherein at least one of the physical I/O devices are in a Network Express Module form factor.

16. The interconnect fabric of claim 9, further comprising an I/O virtualization management entity that provides the communication between at least one of the upstream ports and at least one of the downstream ports.
